(19) United States
(12) Patent Application Publication
(10) Pub. No.: US 2016/0251862 A1
(43) Pub. Date: Sep. 1, 2016

(54) ANTI-SLIP FLOORING

(71) Applicant: Benyuan CHEN, Dongguan City (CN)

(72) Inventor: Benyuan CHEN, Dongguan City (CN)

(21) Appl. No.: 14/405,360

(22) PCT Filed: Sep. 17, 2013
(86) PCT No.: PCT/CN2013/083607

§ 371 Date: Dec. 3, 2014

(30) Foreign Application Priority Data
Jul. 10, 2013 (CN) 201310286494.X

(51) Int. Cl. E04F 15/02; B32B 27/08; E04F 15/10; B32B 27/30; C09J 123/22; B32B 3/30; B32B 27/36

(52) U.S. Cl. CPC E04F 15/02172; B32B 3/30; B32B 27/08; B32B 27/36; B32B 27/304; C09J 123/22; E04F 15/107; E04F 15/105; B32B 2307/554; B32B 2307/744; B32B 2471/00

(57) ABSTRACT

An anti-slip flooring includes a main body. The main body has a bottom surface combined with an adhesive layer. The adhesive layer has a bottom surface configured to contact the ground and provided with raised ribs, wherein the raised ribs define closed concave sucking discs. The adhesive layer is made of a thermal and pressure-sensitive adhesive comprising by weight 35%-55% of a tackifying resin, 10%-20% of a softening agent, 2%-5% of an anti-oxidant, 10%-20% of butyl rubber, and 5%-10% of naphthenic oil, with a total thereof being 100%. Thereby, with the reusability of the thermal and pressure-sensitive to adhesive, the anti-slip flooring can be reused, and is easy to install and uninstall. The adhesive layer allows the anti-slip flooring to be attached to the ground securely, thereby improving the anti-slip capability of the anti-slip flooring. The anti-slip factor at its bottom is 1.7-2.0.

### BACKGROUND OF THE INVENTION

1. Technical Field

The present invention relates to floorings, and more particularly to an anti-slip flooring that has good anti-slip capability.

2. Description of Related Art

It is well known that plastic floorings refer to floor covering made of macromolecular compounds (mainly composed of resins). Plastic floorings have the following features: (1) being moderately priced: as compared with carpets, wooden flooring, stone surfaces and ceramic tile, plastic floorings are less expensive; (2) providing good decorative effects: plastic floorings can be supplied in various types, patterns, prints, colors, textures, and shapes. A plastic flooring has a high-density surface with customizable structure for meeting different preferences and needs of different user groups, by, for example, vividly simulating textures or grains of natural materials such as wood, marble, fabric and granite; (3) being multifunction: plastic floorings are comfortable to step on, giving warm feeling, and capable of heat-insulation, sound-insulation as well as moisture-insulation; (4) being easy to install: plastic floorings can be easily attached to the floor using adhesive, without complicated construction activities that involves the use of cement and sand, so users themselves can lead the whole process from design, material selection to installation; (5) being lightweight: after installation, plastic-flooring covered floor is 10 times lighter than wooden floor, 20 times lighter than tiled floor, and 25 times lighter than stone-paved floor, making plastic floorings particularly suitable for applications such as buildings having more than three stories or office buildings, where plastic floorings help to reduce the load of the buildings and thereby ensure safety, and are easy to move; and (5) requiring little maintenance: plastic floorings can be easily cleaned by mopping or washing, and are fast-drying, while being resistant to wear and endurable. Briefly, plastic floorings have many advantages and are promising on the market.

Anti-slip performance has long been an area to be improved in the field of plastic floorings. Anti-slip performance refers to slip-resistant capability of a plastic flooring, and the anti-slip factor is the main indicator of the slip-resistant capability. There has been proposal about adding some anti-slip patterns to bottom surfaces of plastic floorings for increasing friction with the underlying ground. The proposed patterns include regular hexagons, circles and ripples. However, these proposed patterns are not well designed and combined, and fail to significantly improve the existing plastic floorings that have their anti-slip factors limited to 1.1, forming a major bottleneck for the industry to overcome. As a solution, highly-adhesive curing glue has been used to affix the flooring to the underlying ground. While this solution may ensure the combination, the flooring becomes un-reusable.

### SUMMARY OF THE INVENTION

In view of this, the primary objective of the present invention is to provide an anti-slip flooring that addresses the problems of the existing floorings such as poor anti-slip performance and lack of reusability due to use of curing glue. For achieving the foregoing objective, the present invention implements the following technical schemes:

An anti-slip flooring, comprising a main body and being characterized in: the main body having a bottom surface combined with an adhesive layer, the adhesive layer having a bottom surface that is intended to contact the ground and provided with a plurality of raised ribs, wherein the raised ribs circle and thereby define a plurality of closed concave sucking discs, and the adhesive layer is made of a thermal and pressure-sensitive adhesive comprising by weight 35%-55% of a tackifying resin, 10%-20% of a softening agent, 2%-5% of an anti-oxidant, 10%-20% of butyl rubber, and 5%-10% of naphthenic oil, with a total thereof being 100%.

As a preferred scheme, the tackifying resin comprises a main-body resin and a polyester resin, wherein the main-body resin takes up 25%-40% in the thermal and pressure-sensitive adhesive, and the polyester resin takes up 10%-20% in the thermal and pressure-sensitive adhesive.

As a preferred scheme, the raised ribs form closed non-regular hexagon cells defining the concave sucking discs.

As a preferred scheme, the raised ribs are flexible heat-press patterns formed on the bottom surface of the main body through a hear-press process, wherein the heat-press patterns comprise the closed non-regular hexagons that are repetitive and continuously connected.

As a preferred scheme, the main body comprises in sequence, from bottom to top, a PVC bedding layer, a PVC intermediate layer, a PVC graphic layer and a PVC wear-resistant layer that are stacked and laminated together through a heat-press process, and the adhesive layer is combined with a bottom surface of the PVC bedding layer.

As a preferred scheme, the PVC wear-resistant layer is made of an environmentally-friendly, transparent PVC material.

As compared with the prior art, the present invention possesses significant advantages and beneficial effects. Particularly, from the above-mentioned technical schemes, it is confirmed that:

By using the thermal and pressure-sensitive adhesive to make the adhesive layer, and providing raised ribs on the bottom surface of the adhesive layer that contacts the underlying ground, the disclosed flooring is reusable and easy to install and uninstall in virtue of the reusability of the thermal and pressure-sensitive adhesive, and provides excellent anti-slip performance because the adhesive layer has great self-adhesion and adsorption force that allow it to combine with the ground securely. As measured, the anti-slip factor at its bottom is as high as 1.7-2.0. In addition, the disclosed flooring is low in phenol and VOC, environmentally friendly, non-toxic, dimensionally stable, resistant to frost, and highly conformable, thus being suitable for living houses where the safety and health of the olds and children are of the first importance.

The invention as well as a preferred mode of use, further objectives and advantages thereof will be best understood by reference to the following detailed description of illustrative embodiments when read in conjunction with the accompanying drawings.

### BRIEF DESCRIPTION OF THE DRAWINGS

FIG. 1 is a perspective view of one preferred embodiment of the present invention, showing its internal structure;

FIG. 2 is an enlarged view of Area A of FIG. 1; and

FIG. 3 is a schematic drawing showing a bottom surface of a bedding layer of the preferred embodiment of the present invention.

### DETAILED DESCRIPTION OF THE INVENTION

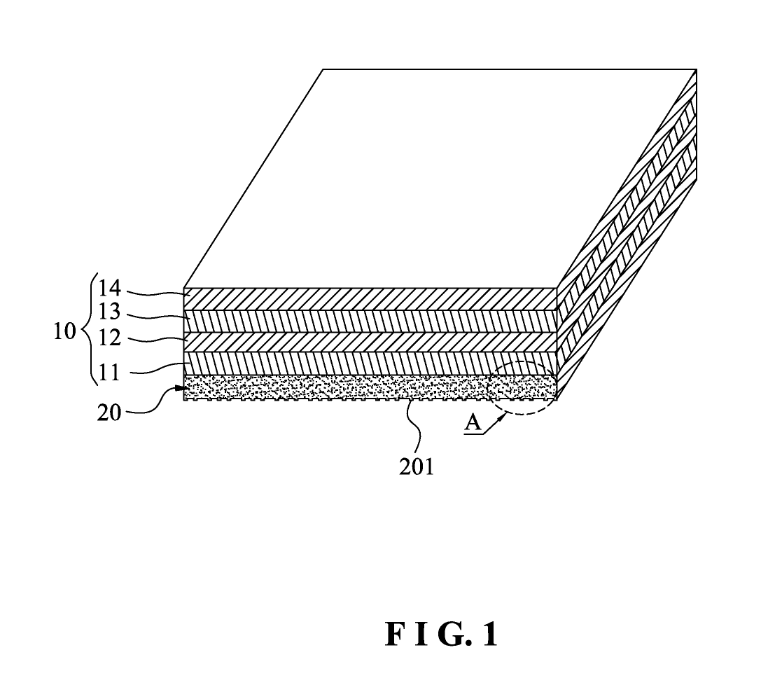

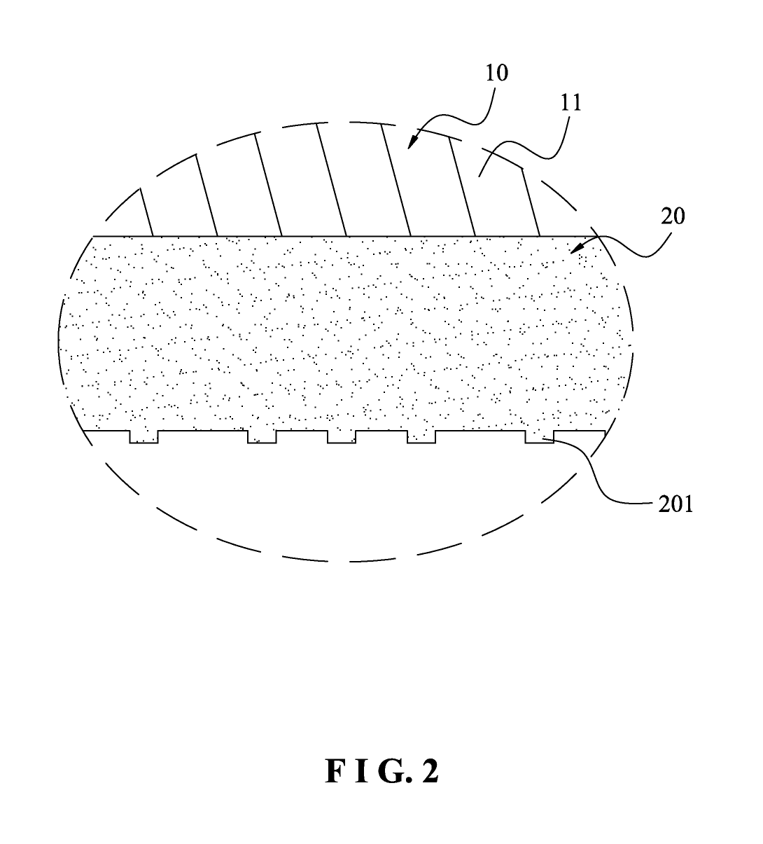

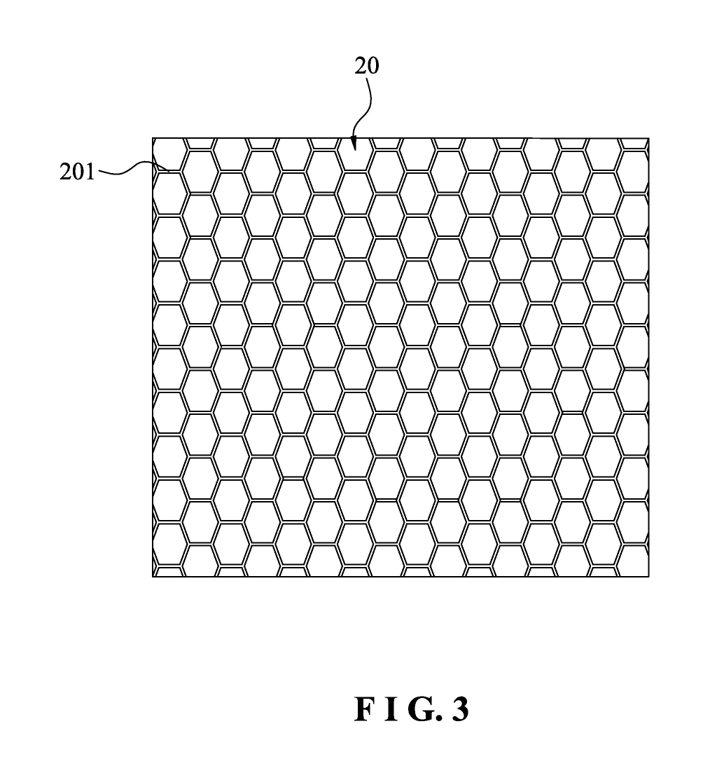

Referring to FIG. 1 through FIG. 3, according to one preferred embodiment of the present invention, a flooring has a main body 10.

The main body 10 has a bottom surface combined with an adhesive layer 20. The adhesive layer 20 has its bottom surface that is intended to contact the underlying ground provided with a plurality of raised ribs 201. The raised ribs 201 circle and thereby define a plurality of closed concave sucking discs. The adhesive layer is made of a thermal and pressure-sensitive adhesive. The adhesive layer 20 is composed by weight: 35%-55% of a tackifying resin, 10%-20% of a softening agent, 2%-5% of an anti-oxidant, 10%-20% of butyl rubber, and 5%-10% of naphthenic oil, with a total thereof being 100%. In the present embodiment, the tackifying resin includes a main-body resin (SBS) and a polyester resin. The tackifying resin comprises a main-body resin and a polyester resin, wherein the main-body resin takes up 25%-40% in the thermal and pressure-sensitive adhesive, and the polyester resin takes up 10%-20% in the thermal and pressure-sensitive adhesive. The adhesive layer 20 made so endows the flooring with a high anti-slip factor, as measured according to the standard testing practice. For example, a specimen of 120 mm*240 mm is first made and then has its bottom surface adhered to the platform of the testing instrument by means of double-sided tape. A sample of the disclosed flooring of 51 mm*51 mm has its bottom surface adhered to a testing iron block by means of double-sided tape. Then the testing instrument is activated to make the platform perform uniform motion, and the maximum reading from a tensometer is recorded. The anti-slip factor can then be obtained by dividing the reading by the weight of the iron block and the sample.

The raised ribs 201 form closed non-regular hexagon cells. The raised ribs 201 are flexible heat-press patterns formed on the bottom surface of the main body through a hear-press process, wherein the heat-press patterns comprise the closed non-regular hexagons that are repetitive and continuously connected.

Moreover, the main body 10 comprises in sequence, from bottom to top, a PVC bedding layer 11, a PVC intermediate layer 12, a PVC graphic layer 13 and a PVC wear-resistant layer 14 that are stacked and laminated together through a heat-press process. The adhesive layer 20 is combined with a bottom surface of the PVC bedding layer 11. The PVC wear-resistant layer 14 is made of an environmentally-friendly, transparent PVC material.

Eight embodiments are herein provided for the adhesive layer 20 with different compositions, and three comparative examples are provided for the thermal and pressure-sensitive adhesive. All the compositions are listed in Table 1.

TABLE 1
Compositions for Embodiments 1-8 and Comparative Examples 1-3

| | | Content (%) | | | | | | | | | | |
|---|---|---|---|---|---|---|---|---|---|---|---|---|
| | | | | | | | | | | Comparative | | |
| | | Embodiment | | | | | | | | Example | | |
| Component | | 1 | 2 | 3 | 4 | 5 | 6 | 7 | 8 | 1 | 2 | 3 |
| Tackifying | Main-Body | 25 | 27 | 39 | 32 | 34 | 40 | 38 | 40 | 55 | 50 | 40 |
| Resin | Resin | | | | | | | | | | | |
| | Polyester | 20 | 19 | 20 | 19 | 19 | 20 | 10 | 16 | | | |
| | Resin | | | | | | | | | | | |

| | | | | | | | | | | | |
|---|---|---|---|---|---|---|---|---|---|---|---|
| Softening Agent | 20 | 19 | 17 | 19 | 19 | 10 | 20 | 18 | 13 | 10 | 15 |
| Anti-Oxidant | 5 | 5 | 5 | 2 | 5 | 4 | 5 | 3 | 2 | 4 | 5 |
| Butyl Rubber | 20 | 20 | 10 | 18 | 18 | 16 | 20 | 15 | 10 | 18 | 20 |
| Naphthenic Oil | 10 | 10 | 9 | 10 | 5 | 10 | 7 | 8 | 20 | 18 | 20 |

The compositions of the adhesive layer as specified Embodiments 1-8 and Comparative Examples 1-3 were tested for their basic properties, as listed in Table 2.

TABLE 2
Basic Property of Adhesive Layer of Flooring

| | | | | | | | | | Comparative | | |
|---|---|---|---|---|---|---|---|---|---|---|---|
| Test | Embodiment | | | | | | | | Example | | |
| Performed | 1 | 2 | 3 | 4 | 5 | 6 | 7 | 8 | 1 | 2 | 3 |
| Anti-Slip Factor | 1.7 | 1.9 | 2.0 | 1.8 | 1.7 | 1.8 | 1.9 | 1.8 | 1.1 | 1.0 | 1.1 |
| Straight Line/ | 0.06/ | 0.04/ | 0.06/ | 0.08/ | 0.09/ | 0.06/ | 0.08/ | 0.096/ | 0.09/ | 0.09/ | 0.11/ |
| Right Angle | 0.02 | 0.02 | 0.01 | 0.05 | 0.04 | 0.02 | 0.01 | 0.05 | 0.03 | 0.04 | 0.04 |
| Wrap At Room | 0.10 | 0.08 | 0.09 | 0.05 | 0.03 | 0.08 | 0.07 | 0.04 | 0.12 | 0.09 | 0.10 |
| Temperature | | | | | | | | | | | |
| Peeling | 7.2 | 6.9 | 6.8 | 7.0 | 7.1 | 6.9 | 6.8 | 6.8 | 6.9 | 6.5 | 6.7 |

Test Conditions:

Anti-slip factor: under 23° C./50RH %, measured according to the standard testing practice.

Straight line/right angle: under 23° C./50RH %, measured as set forth in EN42.7

Wrap at room temperature: under 23° C./50RH %, measured as set forth in EN434.

Peeling: under 23° C./50RH %, measured as set forth in EN431.

It is learned from the results of the tests that the adhesive layer made of the thermal and pressure-sensitive adhesive formulated as disclosed herein, in conjunction with the raised ribs formed thereon, performed well in terms of invention straight line/right angle, wrap at room temperature and peeling tests. The adhesive layer particularly exhibited excellent anti-slip capacity on the tests, demonstrated by its outstanding self-adhesion and adsorption force. The disclosed flooring has its anti-slip factor as high as 1.7-2.0, 63% higher than that of the traditional floorings, whose average anti-slip factor is only 1.1. With such performance, the disclosed flooring successfully overcomes the bottleneck about anti-slip capacity as discussed previously.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. An anti-slip flooring, comprising a main body and being characterized in: the main body having a bottom surface combined with an adhesive layer, the adhesive layer having a bottom surface that is intended to contact the ground and provided with a plurality of raised ribs, wherein the raised ribs circle and thereby define a plurality of closed concave sucking discs, and the adhesive layer is made of a thermal and pressure-sensitive adhesive comprising by weight 35%-55% of a tackifying resin, 10%-20% of a softening agent, 2%-5% of an anti-oxidant, 10%-20% of butyl rubber, and 5%-10% of naphthenic oil, with a total thereof being 100%.

2. The anti-slip flooring of claim 1, being characterized in that the tackifying resin comprises a main-body resin and a polyester resin, wherein the main-body resin takes up 25%-40% in the thermal and pressure-sensitive adhesive, and the polyester resin takes up 10%-20% in the thermal and pressure-sensitive adhesive.

3. The anti-slip flooring of claim 1, being characterized in that the raised ribs form closed non-regular hexagon cells defining the concave sucking discs.

4. The anti-slip flooring of claim 3, being characterized in that the raised ribs are flexible heat-press patterns formed on the bottom surface of the main body through a hear-press process, wherein the heat-press patterns comprise the closed non-regular hexagons that are repetitive and continuously connected.

5. The anti-slip flooring of claim 1, being characterized in that the main body comprises in sequence, from bottom to top, a PVC bedding layer, a PVC intermediate layer, a PVC graphic layer and a PVC wear-resistant layer that are stacked and laminated together through a heat-press process, and the adhesive layer is combined with a bottom surface of the PVC bedding layer.

6. The anti-slip flooring of claim 5, being characterized in that the PVC wear-resistant layer is made of an environmentally-friendly, transparent PVC material.
